(19) United States
(12) Patent Application Publication
(10) Pub. No.: US 2007/0264496 A1
(43) Pub. Date: Nov. 15, 2007

(54) Solderable Plastic EMI Shielding

(75) Inventor: Rocky Richard Arnold, San Carlos, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Wavezero, Inc., Sunnyvale, CA (US)

(21) Appl. No.: 11/744,345

(22) Filed: May 4, 2007

Related U.S. Application Data
(60) Provisional application No. 60/799,814, filed on May 12, 2006.

(51) Int. Cl. B05D 7/00; B32B 15/04; B32B 15/08

(52) U.S. Cl. 428/339; 427/405; 428/457; 428/156; 428/458

(57) ABSTRACT

An electromagnetic interference shield includes a polymer thin film metalized with conductive metals and a solderable material deposited over the conductive metals. The solderable material has a low melting temperature so that the solder can be heated to form a weld joint between a chip (or component) and the solder without damaging the metalized polymer thin film. One example of a low melting temperature solder is SnBi.

### CROSS-REFERENCES TO RELATED APPLICATIONS

This application claims the benefit of U.S. Provisional Application No. 60/799,814, filed May 12, 2006, which is incorporated by reference in its entirety for all purposes.

### BACKGROUND OF THE INVENTION

The present invention relates generally to electromagnetic interference (EMI) shields used with electronic devices. In particular, the present invention relates to attaching electromagnetic interference (EMI) shields to printed circuit boards (PCB).

Most electronic devices manufactured either emit undesirable levels of electromagnetic radiation or are highly susceptible to electromagnetic interference caused by external sources. In either case, electrical and electronic products, especially when they involve any element of wireless technology, require EMI shielding. Typical approaches to the provision of EMI shielding on a PCB include (1) sheet metal shields formed into the appropriate shape and then soldered to the PCB, (2) product housings sprayed or coating with conductive paint, (3) electroplated and electroless plated housings, (4) metalized plastic film shields adhered to the board with conductive adhesives, (5) metalized plastic films adhered mechanically, and (6) a wide variety of flat film products that are conductive and serve to either absorb or deflect EMI.

In all these examples, one central issue is how to affix the EMI shield to the traces of the PCB. Most of the approaches briefly identified above are affected to various degrees by a sub-optimal attachment solution that serves well-enough in low volume applications but suffer in higher volume applications. It is noted that for higher volume applications, the use of small folded/shaped sheet metal structures (e.g., cans) has facilitated assembly by allowing automated assembly machines to be made and used for the placement of the cans which are subsequently soldered to the PCB. The overall effect is a relatively economical method of providing EMI shielding.

With the advent of lightweight polymer film based EMI shielding solutions, the need for an approach for assembly of the shield onto the PCB is needed or alternatively, the plastic shield must become compatible with existing high volume assembly equipment. In high volume applications, the efficiency and cost of attaching a lightweight shield become important in achieving an economic solution. Thus, reliance upon automated equipment is required and the use of existing equipment standards and processes is similarly highly desirable.

Polymer film materials have a low heat distortion point (150° C. or less). The fundamental problem is that the process of soldering is conducted at relatively high temperatures (230° C. for primary process solder using no-lead solder and 160° C. for secondary reflow solder processes using SnBi). These high temperatures will cause the lower heat distortion point polymer films (150° C. or less) to melt.

Fundamentally, the existing solder attachment processes are too hot to allow typical film materials to be used.

Therefore, what is needed is a system and method for reliably and economically attaching an EMI shield comprised of a lightweight plastic film to a PCB using existing automation equipment and soldering processes.

### BRIEF SUMMARY OF THE INVENTION

Embodiments of the present invention include systems and methods for shielding electronic devices from electromagnetic interference radiation using a shaped, formed, or assembled polymer thin film material metalized with conductive metals and solderable materials deposited over the conductive metals. The EMI shield is attached to the PCB board by soldering the solderable material onto the PCB ground traces creating weld joint. This “welded joint” along with the metalized polymer thin film form the EMI shield capability.

In one embodiment of the present invention, a system for shielding electronic devices, includes a polymer thin film metalized with a conductive metal, and a layer made of solderable material deposited over the conductive layer.

In another embodiment of the present invention, the conductive layer is selected from the group consisting of aluminum, tin and gold.

In yet another embodiment of the present invention, the layer made of solderable material is the final layer deposited onto the shield.

In yet another embodiment of the present invention, the polymer thin film includes polyethermide.

In yet another embodiment of the present invention, the polymer thin film includes polyetheretherketone.

In yet another embodiment of the present invention, the layer that is made of solderable material includes SnBi.

In yet another embodiment of the present invention, the layer made of solderable material is a low-melt temperature material which may contain lead or may be lead free (i.e., no-lead).

In yet another embodiment of the present invention, the polymer thin film includes a rib structure.

In yet another embodiment of the present invention, the polymer thin film is less then 5 mils thick and the polymer thin film includes a rib structure.

In yet another embodiment of the present invention, the polymer thin film has a heat distortion temperature of greater than 150° C.

In another embodiment of the present invention, a system for shielding electronic devices, includes a polymer thin film, and a layer made of solderable material deposited over the polymer thin film. The layer made of solderable material can be the final layer deposited onto the shield. The layer made of solderable material is a low-melt temperature material and can include SnBi as well as other no-lead alloys (e.g., tin, silver, copper). The polymer thin film can also include polyethermide or polyetheretherketone and other high temperature capable polymer materials than exhibit high heat distortion temperatures and excellent mechanical properties (stiffness, especially) at temperature. The polymer thin film can also includes a rib structure. In some instances the polymer thin film is less then 5 mils thick. The polymer thin film can have a heat distortion temperature of greater than 150° C.

In another embodiment of the present invention, a method for making an EMI shield for shielding electronic devices, includes metalizing a polymer thin film with a conductive metal, and depositing a layer made of solderable material over the conductive layer.

In yet another embodiment of the present invention, the solderable material is the final layer deposited onto the shield.

In yet another embodiment of the present invention, the step of depositing a layer made of solderable material over the conductive layer includes sputtering the solderable material onto the conductive layer.

In yet another embodiment of the present invention, the step of depositing a layer made of solderable material over the conductive layer includes using thermal evaporation to deposit the layer of solderable material over the conductive layer.

In yet another embodiment of the present invention, the step of depositing a layer made of solderable material over the conductive layer includes electroplating the solderable material onto the conductive layer.

In yet another embodiment of the present invention, the layer of solderable material is deposited directly onto the conductive layer.

In another embodiment of the present invention, a method for making an EMI shield for shielding electronic devices includes providing a polymer thin film and depositing a layer made of solderable material over the polymer thin film. In one embodiment the solderable material can be the final layer deposited onto the shield.

In yet another embodiment of the present invention, the step of depositing a layer made of solderable material over the polymer thin film includes sputtering the solderable material onto the polymer thin film.

In yet another embodiment of the present invention, the step of depositing a layer made of solderable material over the polymer thin film includes using thermal evaporation to deposit the layer of solderable material over the polymer thin film.

In yet another embodiment of the present invention, the step of depositing a layer made of solderable material over the polymer thin film includes electroplating the solderable material onto the polymer thin film.

In yet another embodiment of the present invention, the layer of solderable material is deposited directly onto the conductive layer.

The present invention also provides an EMI shield for direct application to a PCB based on the provision of a final (or only) low melting point metal layer on a thin polymer film substrate that results in an EMI shield which is solderable; that is, it is compatible with existing equipment for the placement and soldering of sheet metal shields to a PCB.

In one embodiment of the present invention, a robust polymer thin film is metalized with one or more layers of conductive metals (e.g., aluminum, tin, gold, etc.) with the final layer comprised of a lead or no-lead solder (e.g., SnBi). The robust film may be polyetherimide (PEI), polyetheretherketone (PEEK) or similar film material capable of preserving its shape while undergoing metalization and soldering. The polymer film may be shaped with or without structural features like ribs. Ribs would be used for especially thin (<5 mils) film thicknesses where the stresses from processing heat and soldering would warp the films unless the stiffness of the formed shape was altered to resist warping. Ideal polymer films would have heat distortion temperatures in the range of 150° C. or above. The film may also come from a class of film materials that are formed by a process called melt processing in which crystalline and amorphous properties of the film material are near the melt temperature, thus allowing use temperatures to be relatively high before thermal distortion occurs. This feature of the film and forming process results in plastic film materials that are relatively stable to highly stable when subjected to metal vapor deposition and soldering via a solder reflow process. The final layer of solderable materials may be SnBi or similar low-melt temperature material.

In another embodiment of the present invention the polymer EMI shield may contain only a single (and final) layer of solderable material.

In yet another embodiment of the present invention the polymer EMI shield may have one or more layers, including the final layer, created by PVD techniques (sputtering or thermal evaporation) or electroplating.

### BRIEF DESCRIPTION OF THE DRAWINGS

FIG. 1 is a top view EMI shield having a polymer film along with a layer of low melting point alloy solder, in accordance with an embodiment of the present invention.

FIG. 2 is a bottom view of a one-cavity EMI shield with a rib structure and a contact portion where the EMI shield makes contact with the PCB, in accordance with an embodiment of the present invention.

FIG. 3A illustrates a side view of the EMI shield having a rib structure and a rectangular shaped form comprising solderable material used to solder the EMI shield to the ground traces of the PCB, in accordance with an embodiment of the present invention.

FIG. 3B illustrates another side view of the EMI shield having a rib structure and continuous rectangular shaped form comprising solderable material used to solder the EMI shield to the ground traces of the PCB, in accordance with an embodiment of the present invention.

FIG. 3C illustrates another side view of the EMI shield having a rib structure and discrete rectangular shaped form comprising solderable material used to solder the EMI shield to the ground traces of the PCB, in accordance with an embodiment of the present invention.

FIG. 4 illustrates a side view of the EMI shield having a rib structure and a solderable material (illustrated as a cylinder) used to solder the EMI shield to the ground traces of the PCB, in accordance with another embodiment of the present invention.

FIG. 5 illustrates a side view of the EMI shield having a rib structure and a pair of cylindrically shaped forms (for illustration purposes) comprising solderable material used to solder the EMI shield to the ground traces of the PCB, in accordance with another embodiment of the present invention.

FIG. 6 illustrates a side view of the EMI shield with a sturdier cover and a rectangular shaped form comprising solderable material used to solder the EMI shield to the ground traces of the PCB, in accordance with another embodiment of the present invention.

FIG. 7 is a flowchart illustrating a method for making a PCB with an EMI shield for shielding electronic devices, in accordance with an embodiment of the present invention.

### DETAILED DESCRIPTION OF THE INVENTION

Embodiments of the present invention provide systems and methods for reliably and economically attaching an EMI shield containing a lightweight plastic film to a PCB using existing automation equipment and soldering processes. The systems and methods for shielding electronic devices include using polymer thin films metalized with conductive metals and solderable materials deposited over the conductive metals. The EMI shield is attached to the PCB board by soldering the solderable material onto the PCB ground traces creating weld joint. This weld joint along with the metalized polymer thin film form the EMI shield used to protect the enclosed electronic devices.

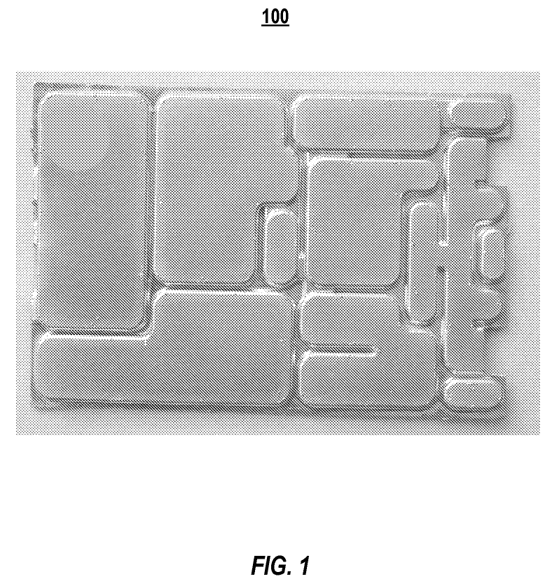

FIG. 1 is a top view 100 of an EMI shield made of a metalized polymer film and configured with a layer of low melting point alloy solder. The EMI shield includes a polymer thin film metalized with a conductive metal and a layer made of solderable material deposited over the conductive layer. The conductive layer can be aluminum, tin or gold or other metals that are at least moderately conductive (i.e., nickel, stainless steel). The polymer thin film can include various types such as polyethermide or polyetheretherketone where the distinguishing characteristic is high heat distortion temperature. The layer made of solderable material can include compounds such as SnBi. In one embodiment the solderable material is a low-melting temperature material.

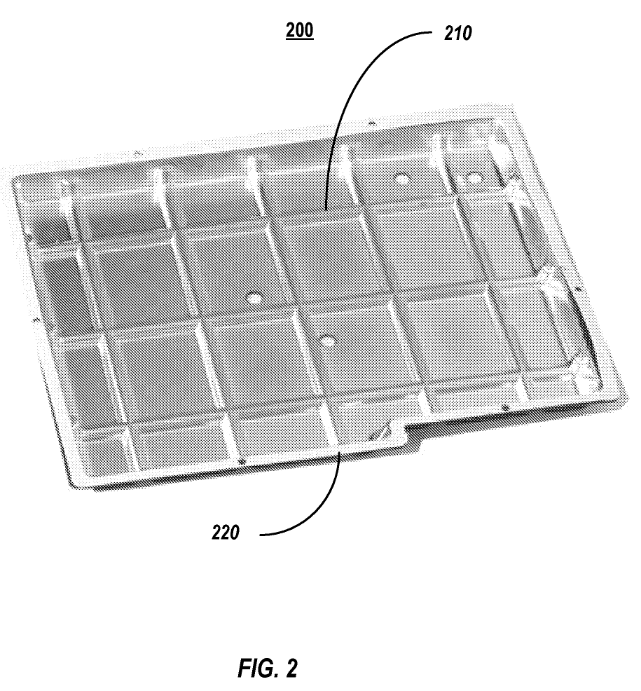

The polymer thin film can include a rib structure as described in more detail with reference to FIG. 2 below. In one embodiment the polymer thin film is less then 5 mils thick. In this embodiment, the polymer thin film can also include a rib structure. The polymer thin film also has a high heat distortion temperature. For example, the polymer thin film can have a heat distortion temperature greater than 150° C. In the case of thin polymer film materials (<10 mils), the ribs serve to make the sectional mechanical properties higher; that is, the structure is thicker and though properties decline with temperature, they are still sufficient to maintain the geometrical attributes of the desired shield.

In another embodiment of the invention, the EMI shield includes a polymer thin film and a layer made of solderable material deposited over the entire polymer thin film. The solderable material, which is deposited over the entire polymer film, serves the dual role of both metalizing the polymer film and preparing the polymer film for soldering onto the ground traces of the PCB. If the polymer film is metalized with a solderable material then the individual metallization layer need not be done. The layer made of solderable material can also include SnBi or some other low melting solderable material. The polymer thin film can also include various materials such as polyethermide or polyetheretherketone. In one embodiment the polymer thin film is made of polyethermide which is less then 5 mils thick and includes a rib structure that has a high heat distortion temperature. In this one embodiment, the polymer thin film has a heat distortion temperature greater than 150° C.

FIG. 2 is a bottom view 200 of an EMI shield showing with a rib structure 210 and contact portions 220 of the shield that come into contact with ground traces of the PCB. The rib structure 210, which is used to prevent warping, forms a lattice that adds to the stiffness of the structure. The stiff structure resists warping in the presence of high heating from vapor deposition and/or the soldering processes. The contact portions 220 of the shield, which makes contact with the ground traces of the PCB, are located around the perimeter of the shield forming a one-cavity shield for enclosing the components of the PCB that are to be shielded. The contact portion 220 is coated with the layer made of solderable material described above with reference to FIG. 1. In one application, one surface (the inside in this case) is metalized with a solderable metal coating; however, complete metalization of all surfaces is possible with a solderable metal coating and may be done in the interest of process economics.

In one embodiment the solderable coating layer is deposited along the edges forming the contact portion 220, which is where the cover makes contact with the ground trace of the PCB. This type of selective coating can be accomplished by first applying a negative mask that is water soluble before metalization. Subsequent removal of the mask reveals the selectively coated perimeter. Although the thickness of the deposited solder layer can vary, in most embodiments it is relatively thin (e.g., less than 10 micrometers). In one embodiment, the solder is thermally evaporated onto the cover and has a thickness of about 1±0.5 micrometers.

The solderable metal coating can be deposited as a continuous bead of material that goes all the way around the contact portion 220 with no gaps. Alternatively, the solder can be deposited as discrete beads that are close enough to each other that they will combine when the solder is heated and melted. In some applications, the solder is positioned as discrete beads along the contact portion 220 so that the beads are far enough apart, that even after they melt during the soldering process, the solder does not form a continuous bead around the contact portions 220 of the cover.

Since the layer made of solderable material can include compounds such as SnBi, which are low-melt temperature materials, the solder layer located on the contact portion 220 will melt before the polymer thin films located on the structure ribs 210 melt. With this configuration, the polymer films can be used in the shield while at the same time a solderable material can be used to solder the shield to the ground traces of the PCB. By using a polymer thin film in the EMI shield while still being able to solder the EMI shield onto the PCB, a relatively economic and robust EMI shield can be made.

Although the embodiment illustrated in FIG. 2 shows that the low melting point solderable material is the final layer deposited onto the shield, those skilled in the art will realize that other layers can be deposited after the solder layer. For example, it may be desirable to deposit a wetting agent onto the solderable material.

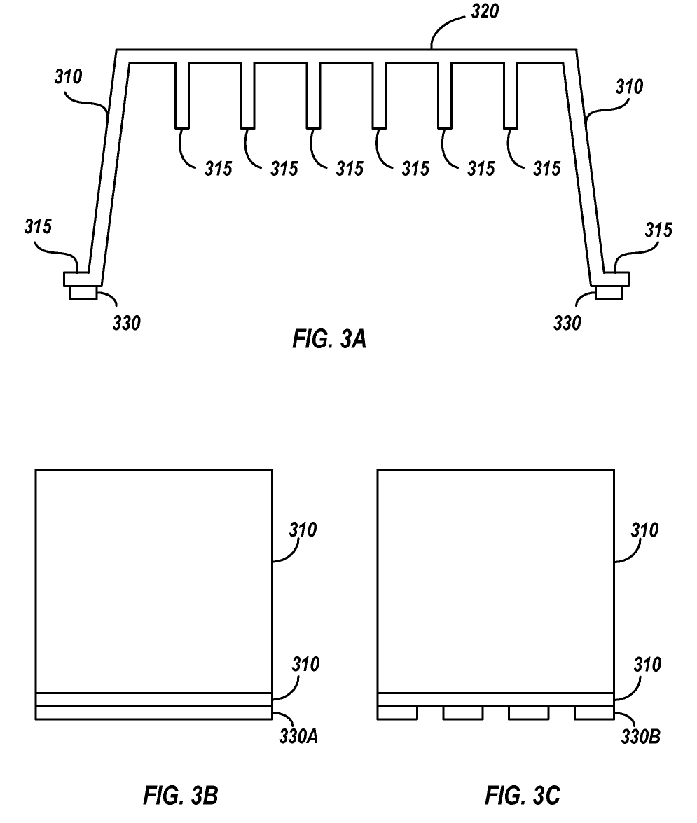

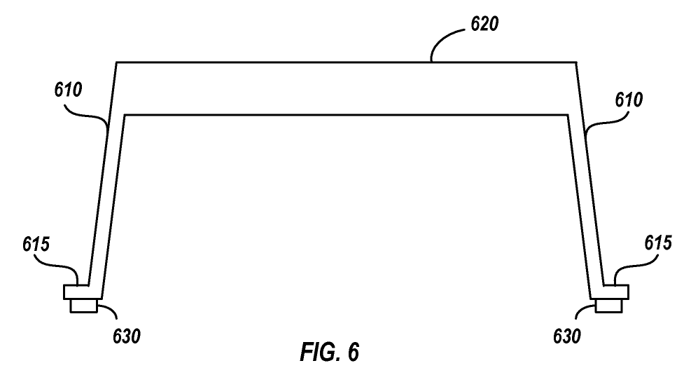

FIG. 3A illustrates a side view of the EMI shield having a rib structure and a rectangular shaped form comprising solderable material used to solder the EMI shield to the ground traces of the PCB. This solderable material is the result of soldering processes that pre-apply via solder paste an appropriate amount of material for the application wherein the solder is caused to melt just wetting the solder layer of the shield. The side view of the EMI shielding includes a body 310, an edge 315, a cover 320, a rib structure 325, and a solderable material 330. The body 310, edge 315 cover 320 and rib structure 325 are formed as one continuous piece and include a polymer thin film that has been metalized to shield EMI radiation. The rib structure 325 is constructed in a lattice pattern and is used to provide support to the shield so that it is separated from the electronic components that will be enclosed by the EMI shield. The lengths of the rib structure 325 are not specified because they will be determined according the thickness of the body 310 and cover 320. If a thicker body and cover are used then the rib structure can be made smaller or eliminated all together as described below with reference to FIG. 6. The solderable material 330 is deposited along the edge 315 so that when the EMI shield is brought into contact with a PCB a seal can be made along the edge 315 and the PCB. The solderable material is heated to its reflow temperature and allowed to bond with the PCB when it cools and solidifies. Since the solderable material is a low melting temperature material it can be used with the polymer film of the body 310, edge 315, cover 320 and rib structure 325.

FIG. 3B illustrates another side view of the EMI shield having a rib structure and a continuous rectangular shaped form comprising solderable material used to solder the EMI shield to the ground traces of the PCB. This side view of the EMI shielding includes the body 310, the edge 315, and a continuous rectangular shaped form comprising solderable material 330A. The solderable material 330A is layered over the bottom side of the edge 315 as a continuous strip of rectangular material 330A. When the solderable material 330A is heated it begins to flow and spread. As solderable material cools it solidifies and forms a bond that is continuous around the entire edge of the shield. This bond forms the part of the EMI shield because EMI radiation does not penetrate this seal easily. The rectangular distribution of the solderable material is advantages in some applications because of the way solderable material spread at the melting temperature.

FIG. 3C illustrates another side view of the EMI shield having a rib structure and discrete rectangular shaped forms comprising solderable material used to solder the EMI shield to the ground traces of the PCB. This side view of the EMI shield includes the body 310, the edge 315, and a plurality of discrete rectangular shaped forms comprising solderable material portions 330B which are separated by a separation distance 335. Unlike the embodiment illustrated in FIG. 3B, the solderable material 330B is layered over the bottom side of the edge 315 in discrete portions rather than as a continuous strip. The discrete portions are separated by a separation distance 335. The separation distance 335 is small enough that the gap between solderable material after melting and solidifying is small enough to shield electromagnetic radiation. In some instances it may be optimum to have the solidified solderable material form a continuous strip whereas in other embodiments small separation gaps may be sufficient to shield EMI. There are several advantages of using discrete amounts of solderable material including using less solderable material. Additionally, small gaps in the soldered material may be advantages because it will allow for more uniform temperature distributions between the different electronic components, provided that EMI is properly shielded.

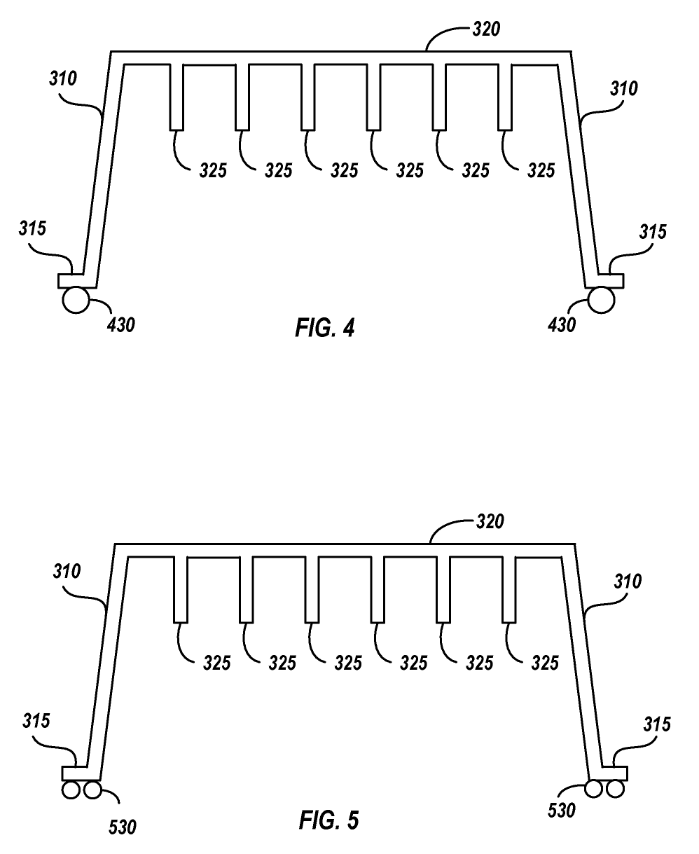

FIG. 4 illustrates a side view of another EMI shield having a rib structure and a solderable material illustrated as a cylinder used to solder the EMI shield to the ground traces of the PCB. The side view of the EMI shield includes a body 310, an edge 315, a cover 320, a rib structure 325, and a solderable material 430 laid out in a cylindrical form. The solderable material 430 is deposited along the edge 315 in a cylindrical fashion so that the cross section shows a circular pattern. When the EMI shield is brought into contact with a PCB, a seal is made along the edge 315 and the PCB. The solderable material is heated to its reflow temperature and allowed to bond with the PCB when it cools and solidifies. Since the solderable material is a low melting temperature material it can be used with the polymer film of the body 310, edge 315, cover 320 and rib structure 325. In some applications it may be desirable to deposit the solderable material in a cylindrical pattern instead of the rectangular pattern illustrated in FIG. 3A. For example, a cylindrical pattern may reduce the amount of heat that is transferred to the body 310, the edge 315, the cover 320, and the rib structure 325 and therefore may allow using thinner polymer films.

FIG. 5 illustrates a side view of the EMI shield having a rib structure and a pair of cylindrically shaped forms comprising solderable material used to solder the EMI shield to the ground traces of the PCB. The side view of the EMI shielding includes a body 310, an edge 315, a cover 320, a rib structure 325, and a solderable material 530 laid out in a pair of cylindrical forms. The solderable material 530 is deposited along the edge 315 in a pair of cylindrical forms so that the cross section shows a pair of circular pattern. When the EMI shield is brought into contact with a PCB a seal can be made along the edge 315 and the PCB. The solderable material is heated to its reflow temperature and allowed to bond with the PCB when it cools and solidifies. Since the solderable material is a low melting temperature material it can be used with the polymer film of the body 310, edge 315, cover 320 and rib structure 325. In some applications it may be desirable to deposit the solderable material in a cylindrical pair pattern instead of the rectangular pattern illustrated in FIG. 3A or the single cylindrical pattern illustrated in FIG. 4. For example, a cylindrical pair pattern may cause better spreading of the solderable material when it is melted which results in a better EMI shield.

FIG. 6 illustrates a side view of the EMI shield with a sturdier cover and a rectangular shaped form comprising solderable material used to solder the EMI shield to the ground traces of the PCB. The side view of the EMI shielding includes a body 610, an edge 615, a cover 620, and a solderable material 630. The body 610, edge 615, and cover 620 are formed as one continuous piece and include a polymer thin film that has been metalized to shield EMI radiation. Unlike the embodiments described above with reference to FIG. 3-5, this embodiment does not have a rib structure 325. In the embodiments of FIG. 3-5 the rib structure was used to support the shield. This embodiment of the invention uses a thicker and sturdier body, edge and cover instead of a rib structure. The sturdier body and cover provide sufficient to support so that a rib structure is not needed. The solderable material 630 is deposited along the edge 615 so that when the EMI shield is brought into contact with a PCB a seal can be made along the edge 615 and the PCB. The solderable material is heated to its reflow temperature and allowed to bond with the PCB when it cools and solidifies. Since the solderable material is a low melting temperature material it can be used with the polymer film of the body 610, edge 615 and cover 620. Moreover, the thicker body 610, edge 615 and cover 620 can provide an advantage when heating the solder to the melting point because it takes more energy to raise the temperature of the body 610, edge 615 and cover 620 the it does to raise the temperature of the less massive body 310, edge 315, cover 320 and rib structure 325.

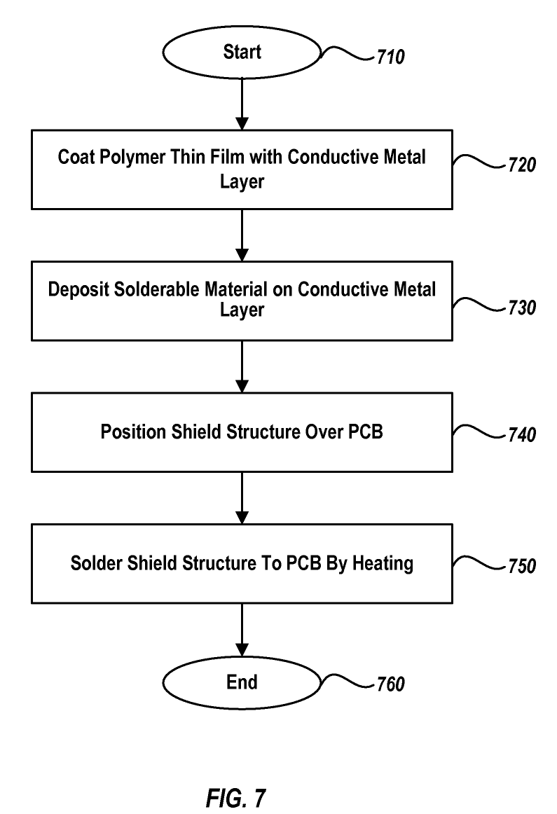

FIG. 7 is a flowchart illustrating a method for making an EMI shield for shielding electronic devices. The process starts in step 710 where a substrate which consists of a polymer thin film is provided. The polymer thin film can be a shaped substrate configured to be an EMI shield once subsequent layers are deposited on the substrate. Next in step 720, the polymer thin film is coated with a conductive metal layer. Next in step 730, a layer made of solderable material is deposited over the conductive layer. After the solderable material is deposited onto the polymer thin film, the shield structure including the polymer thin film, the conductive metal layer and the solderable material is positioned over the ground traces of the PCB in step 740. In step 750, the solderable material is heated to its melting point causing it to weld or solder with the PCB. The process ends in step 760 where the PCB is sent on to the next step in the manufacturing process.

In step 720, the conductive metal layer can be coated by metallization or by other techniques. If metallization is used, then the metal layer can be vacuum deposited onto the polymer film using techniques such as sputtering, CVD, thermal evaporation, etc. If the metallization is done with simpler means, then it can be deposited onto the polymer film using other techniques such as painting.

In step 730, the layer made of solderable material can be deposited over the conductive layer using various techniques and methods including sputtering, thermal evaporation, electroplating, and etch. The solderable material can also be deposited directly onto the conductive layer. Alternatively, an intermediate layer can be deposited in between the conductive layer and the solderable material. The intermediate layer can be, for example, nickel or some other material that controls the wetting to the solderable material when it is heated.

In step 740 the shield structure is positioned over the portion of the PCB board where it will be soldered onto. In one example, the shield will be soldered to the ground traces of the PCB and shield structure is therefore maneuvered over the ground traces of the PCB. The PCB board contains portions with electronics that require shielding for optimal performance and other electronics that do not require shielding. The shield structure can be configured to fit over just those portions of the PCB that support the electronic components that are sensitive and need shielding. If the EMI shield is configured to be connected to the ground trace of the PCB, then the EMI shield is positioned so the solder material is abutting the ground traces of the PCB. In this step, the shield structure is moved and positioned with the use of a robot, for example. In one embodiment, the entire PCB may be shielded, in which case, this step aligns the PCB ground traces with the solderable material of the shield structure so that the solder is positioned adjacent the PCB ground traces.

In step 750, the solder is heated to its melting point causing a solder joint between the PCB and the shield structure to form. Since the solderable material is a low-melt temperature material, the temperature does not need to be raised very high. Also, since the polymer thin film has a high heat distortion temperature (i.e., greater than 150° C.), increasing the temperature to the melting point of the solderable material does not distort the polymer while permitting the solder to form a solder joint.

In step 760, the PCB with soldered shield structure is sent on to the next processing step. This can include further wiring of the PCB, decorative finishing of the shielded structure, etc.

It will also be recognized by those skilled in the art that, while the invention has been described above in terms of preferred embodiments, it is not limited thereto. Various features and aspects of the above-described invention may be used individually or jointly. Further, although the invention has been described in the context of its implementation in a particular environment and for particular applications, those skilled in the art will recognize that its usefulness is not limited thereto and that the present invention can be utilized in any number of environments and implementations.

What is claimed is:

1. A system for shielding electronic devices, comprising:
a polymer thin film metalized with a conductive metal; and
a layer made of solderable material deposited over said conductive layer.

2. The system of claim 1 wherein said layer made of solderable material is the final layer deposited onto the system for shielding electronic devices.

3. The system of claim 1 wherein said conductive layer is selected from the group consisting of aluminum, tin and gold.

4. The system of claim 1 wherein said polymer thin film comprises polyethermide.

5. The system of claim 1 wherein said polymer thin film comprises polyetheretherketone.

6. The system of claim 1 wherein said layer made of solderable material comprises SnBi.

7. The system of claim 1 wherein said layer made of solderable material is a low-melt temperature material.

8. The system of claim 1 wherein said polymer thin film comprises rib structure.

9. The system of claim 1 wherein said polymer thin film is less then 5 mils thick and said polymer thin film comprises a rib structure.

10. The system of claim 1 wherein said polymer thin film has a heat distortion temperature of greater than 150° C.

11. A system for shielding electronic devices, comprising:
a polymer thin film; and
a layer made of solderable material deposited over said polymer thin film.

12. The system of claim 11 wherein said polymer thin film comprises polyethermide.

13. The system of claim 11 wherein said polymer thin film comprises polyetheretherketone.

14. The system of claim 11 wherein said layer made of solderable material comprises SnBi.

15. The system of claim 11 wherein said layer made of solderable material is a low-melt temperature material.

16. The system of claim 11 wherein said polymer thin film comprises rib structure.

17. The system of claim 11 wherein said polymer thin film is less then 5 mils thick and said polymer thin film comprises a rib structure.

18. The system of claim 11 wherein said polymer thin film has a heat distortion temperature of greater than 150° C.

19. A method for making an EMI shield for shielding electronic devices, comprising:
metalizing a polymer thin film with a conductive metal; and
depositing a layer made of solderable material over said conductive layer.

20. The method of claim 19 wherein said step of depositing a layer made of solderable material over said conductive layer comprises sputtering said solderable material onto said conductive layer.

21. The method of claim 19 wherein said step of depositing a layer made of solderable material over said conductive layer comprises using thermal evaporation to deposit said layer over said conductive layer.

22. The method of claim 19 wherein said step of depositing a layer made of solderable material over said conductive layer comprises electroplating said solderable material onto said conductive layer.

23. The method of claim 19 wherein said layer made of solderable material is deposited directly onto said conductive layer.

24. A method for making an EMI shield for shielding electronic devices, comprising:
providing a polymer thin film; and
depositing a layer made of solderable material over said polymer thin film.

25. The method of claim 24 wherein said step of depositing a layer made of solderable material over said polymer thin film comprises sputtering said solderable material onto said polymer thin film.

26. The method of claim 24 wherein said step of depositing a layer made of solderable material over said polymer thin film comprises using thermal evaporation to deposit said layer made of solderable material over said polymer thin film.

27. The method of claim 24 wherein said step of depositing a layer made of solderable material over said polymer thin film comprises electroplating said solderable material onto said polymer thin film.

28. The method of claim 24 wherein said layer made of solderable material is deposited directly onto said conductive layer.
